(19) United States
(12) Patent Application Publication
(10) Pub. No.: US 2012/0125213 A1
(43) Pub. Date: May 24, 2012

(54) CLICHE AND MANUFACTURING METHOD FOR THE SAME

(75) Inventors: Jae Bon KOO, Daejeon (KR); Minseok Kim, Cheongju-si (KR); Taeyoub Kim, Seoul (KR); In-Kyu You, Daejeon (KR)

(73) Assignee: ELECTRONICS AND TELECOMMUNICATIONS RESEARCH INSTITUTE, Daejeon (KR)

(21) Appl. No.: 13/193,668

(22) Filed: Jul. 29, 2011

(30) Foreign Application Priority Data
Nov. 22, 2010 (KR) 10-2010-0116324

(51) Int. Cl. B41N 1/04; B41C 3/00

(52) U.S. Cl. 101/395; 101/401.1

(57) ABSTRACT

Provided is a cliche and a method of manufacturing the cliche which can increase or maximize productivity and production yield. The manufacturing method of the cliche includes providing a substrate, forming organic patterns protruding on the substrate, and forming an ink absorption layer on the organic patterns or on the substrate exposed from the organic patterns.

### CROSS-REFERENCE TO RELATED APPLICATIONS

This U.S. non-provisional patent application claims priority under 35 U.S.C. §119 of Korean Patent Applications No. 10-2010-0116324, filed on Nov. 22, 2010, the entire contents of which are hereby incorporated by reference.

### BACKGROUND

The present disclosure herein relates to a printing apparatus, and more particularly, to a cliche of a reverse offset printing apparatus and a manufacturing method for the cliche.

Printing technologies can make many reproductions from letters, pictures, and photographs, etc. Printing technologies are being researched and developed in a direction for the mass production of printed matter at low cost. Printing technologies are being used in manufacturing processes of display devices, such as the manufacture of color filters. For example, a reverse gravure offset printing apparatus may include a blanket roll that prints ink on printed matter, and a cliche of a reverse printing plate that removes the ink applied to the entire surface of the blanket roll in a predetermined pattern. A typical cliche may be patterned mainly by a wet etching method. However, there are limitations in that a cliche manufactured by a typical wet etching method cannot be provided with a fine line width of about 10 μm or less and a high aspect ratio.

### SUMMARY

The present disclosure provides a cliche having a fine line width and a high aspect ratio, and manufacturing method for the cliche.

The present disclosure also provides a cliche and a manufacturing method for the cliche which can increase or maximize productivity and production yield.

Embodiments of the inventive concept provide a method of manufacturing a cliche including: forming a conductive metal pattern on a top of photoresist patterns or on a substrate exposed between the photoresist patterns. The method includes providing a substrate; forming organic patterns on the substrate; and forming an ink absorption layer on the organic patterns or on the substrate exposed from the organic patterns.

In some embodiments, the organic patterns may include a photoresist. The photoresist may be a negative-type. The photoresist may include an SU-8 photoresist.

In other embodiments, the ink absorption layer may include at least one metal layer. The metal layer on the organic patterns may be formed by a chemical vapor deposition method or a physical vapor deposition method. The metal layer between the organic patterns may be formed by an electroplating method, an electro-precipitation method, or an anodizing method. The substrate may include a metal plate. The substrate may include an insulation plate or a wafer. Forming of at least one electrode layer between the insulation plate or the wafer and the metal layer may be further included.

In still other embodiments, removing of the organic patterns between the ink absorption layers may be further included.

In even other embodiments of the inventive concept, a cliche includes a substrate; stack patterns protruding on the substrate; and an ink absorption layer disposed on the stack patterns.

In yet other embodiments, the stack patterns may include organic patterns. The organic patterns may include a negative-type photoresist. The negative-type photoresist may include an SU-8 photoresist.

In further embodiments, the ink absorption layer may include a metal layer. The metal layer may include at least one of chromium, nickel, aluminum, or molybdenum.

In still further embodiments, the stack patterns may include the same or different kinds of metal layers from the metal layer of the ink absorption layer. The substrate may include a metal plate. A metal thin film formed between the substrate and the stack patterns may be further included.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view of a cliche according to a first embodiment of the inventive concept.

FIGS. 2A through 2E are cross-sectional views illustrating a manufacturing method for a cliche according to the first embodiment of the inventive concept.

FIG. 3 is a cross-sectional view illustrating a cliche according to a second embodiment of the inventive concept.

FIGS. 4A through 4G are cross-sectional views illustrating a manufacturing method for a cliche according to the second embodiment of the inventive concept.

FIG. 5 is a cross-sectional view illustrating a cliche according to a third embodiment of the inventive concept.

FIGS. 6A through 6H are cross-sectional views illustrating a manufacturing method for a cliche according to the third embodiment of the inventive concept.

### DETAILED DESCRIPTION OF THE EMBODIMENTS

Preferred embodiments of the present invention will be described below in more detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

In the following description, the technical terms are used only for explaining specific embodiments while not limiting the present invention. In the inventive concept, the terms of a singular form may include plural forms unless otherwise specified. The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto. Additionally, in the specification, it will be understood that when an element such as a layer, film, region, or substrate is referred to as being “on” another element, it can be directly on the other element or intervening elements may also be present.

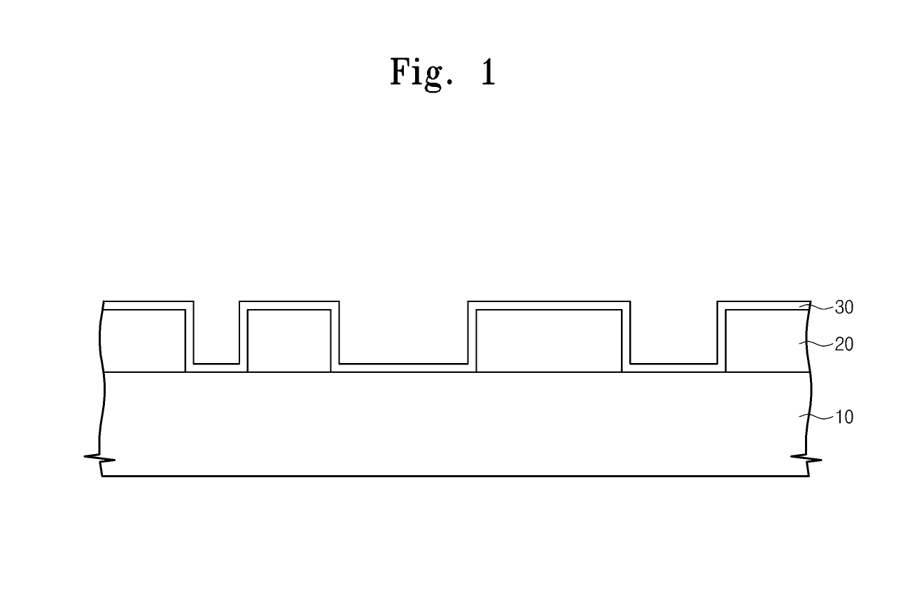

FIG. 1 is a cross-sectional view of a cliche according to a first embodiment of the inventive concept.

Referring to FIG. 1, the cliche according to the first embodiment of the inventive concept may include photoresist patterns 20 formed on a substrate 10, and an ink absorption layer 30 formed on the photoresist patterns 20 and the substrate 10. The photoresist patterns 20 may include a raised pattern protruding from a surface of the substrate 10. The photoresist patterns 20 may have a fine line width and a high aspect ratio. Therefore, the cliche according to the first embodiment of the inventive concept can increase or maximize productivity and production yield.

The photoresist patterns 20 may be organic patterns and stack patterns which include polyimide. The photoresist patterns 20 may be of a negative-type. The photoresist patterns 20 may reduce oxidation or contamination of the ink absorption layer 30 when they are of a negative-type rather than a positive-type. The negative-type photoresist patterns 20 may include an SU-8 photoresist. The SU-8 photoresist may include an epoxy component. The SU-8 photoresist patterns 20 may have a thickness of about 10 μm or more in the range of about 0.1 μm to about 1 mm.

The photoresist patterns 20 may have a fine line width corresponding to an ultraviolet wavelength generated from a light source of an exposure apparatus (not shown). For example, a G-line exposure apparatus may generate ultraviolet rays having a wavelength of about 436 nm. Also, an I-line exposure apparatus may generate ultraviolet rays having a wavelength of about 365 nm. Therefore, the photoresist patterns 20 may have a fine line width of about 5 μm or more. Also, the photoresist patterns 20 may have a high aspect ratio of about 10 μm or more.

The ink absorption layer 30 may include a layer of metal such as chromium, nickel, copper, aluminum, gold, and silver. The ink absorption layer 30 may be formed on the substrate 10 and the photoresist patterns 20. The ink absorption layer 30 may be formed on an entire surface of the substrate 10 by a chemical vapor deposition method or a physical vapor deposition method. The ink absorption layer 30 on the photoresist patterns 20 may absorb ink on a printing roll (not shown). On the other hand, the ink absorption layer 30, which is formed on the substrate 10 between the photoresist patterns 20, may not be in contact with ink on the printing roll due to a high aspect ratio of the photoresist patterns 20.

Therefore, the cliche according to the first embodiment of the inventive concept can increase or maximize productivity and production yield.

A manufacturing method of a cliche according to the first embodiment of the inventive concept having the foregoing configuration is as follows.

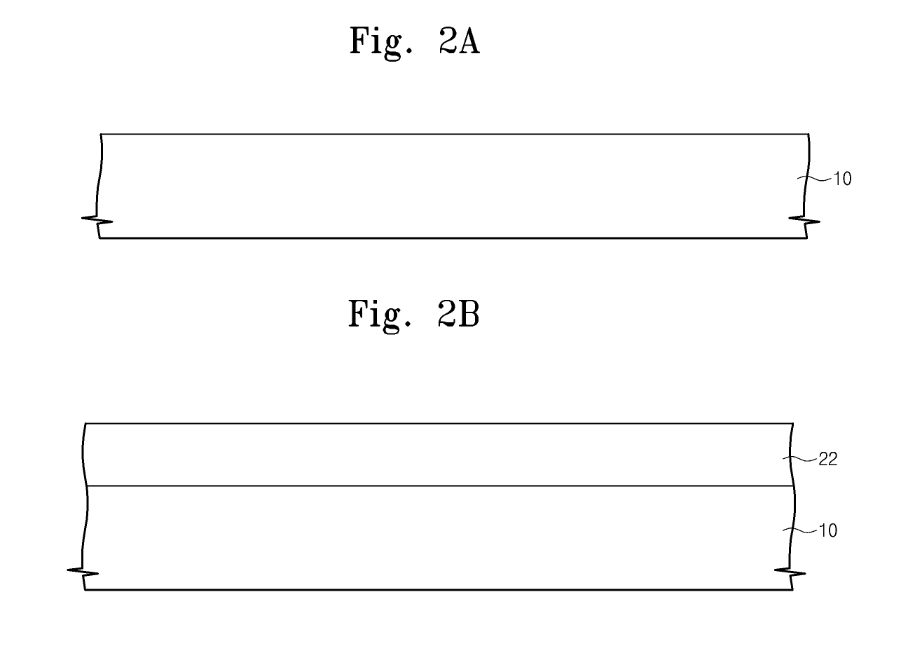

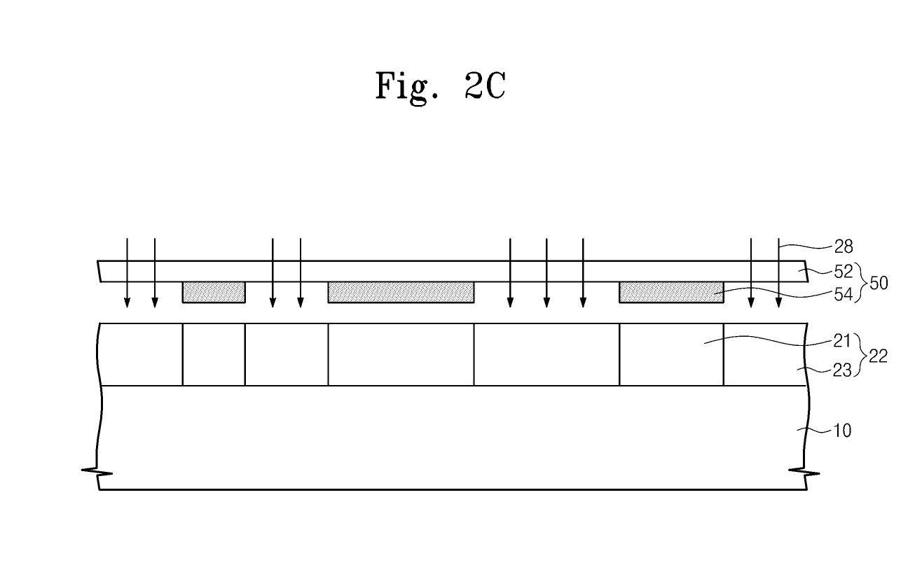

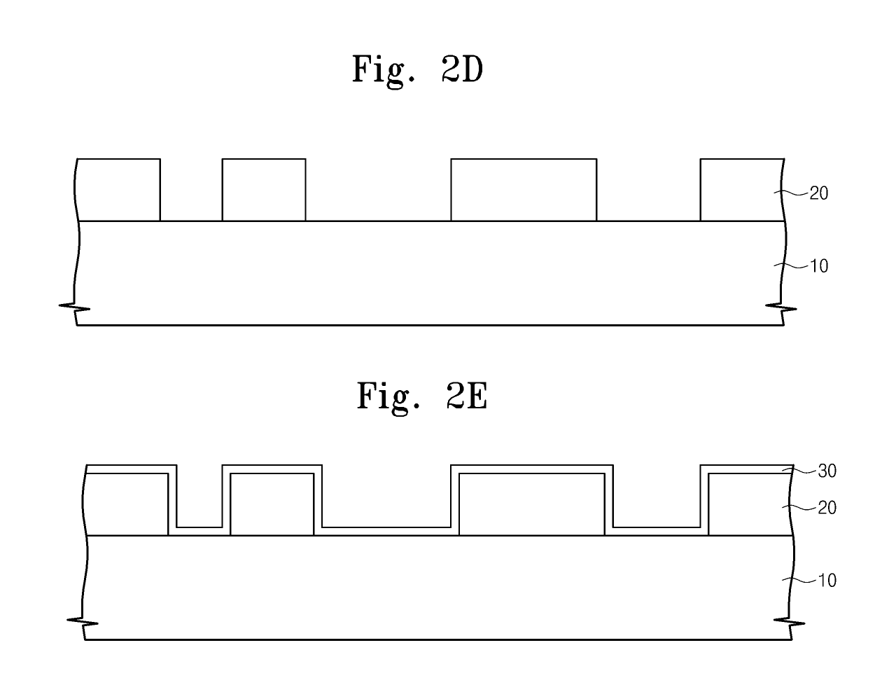

FIGS. 2A through 2E are cross-sectional views illustrating the manufacturing method for the cliche according to the first embodiment of the inventive concept.

Referring to FIG. 2A, a substrate 10 having a flat surface may be provided. The substrate 10 may include an insulation plate, a wafer, or a flat metal plate.

Referring to FIG. 2B, a photoresist 22 may be applied to an entire surface of the substrate 10. The photoresist 22 may be applied on the substrate 10 by a spin coater (not shown). The photoresist 22 may include a negative-type SU-8 photoresist. The photoresist 22 may be applied to a thickness of about 10 μm.

Referring to FIG. 2C, the photoresist 22 may be exposed to ultraviolet rays 28. The photoresist 22 may be exposed to the ultraviolet rays 28 passing through a photomask 50. The photomask 50 may include a transparent glass substrate 52 and mask patterns 54 formed on the glass substrate 52. The mask patterns 54 may selectively shield the ultraviolet rays 28 which are incident on the photoresist 22 from a light source (not shown). The photoresist 22 may include an exposed region 21 exposed to the ultraviolet rays and an unexposed region 23 unexposed to the ultraviolet rays in which their chemical structures may be different from each other. For example, a negative-type photoresist 22 may include polymer. The negative-type photoresist 22 may form a polymer chain when exposed to the ultraviolet rays 28. The exposed region 21 and unexposed region 23 may be divided by a fine line width of about 5 μm or more.

Referring to FIG. 2D, the photoresist 22 of the unexposed region 23 may be removed. The photoresist 22 may be removed by a developer. The photoresist 22 of the exposed region 21 may become photoresist patterns 20 remaining on the substrate 10. Thereafter, the photoresist patterns 20 may be undergone a bake process. The photoresist patterns 20 may include organic patterns or stack patterns.

Referring to FIG. 2E, an ink absorption layer 30 may be formed on the photoresist patterns 20 and the substrate 10. The ink absorption layer 30 may include a layer of metal such as chromium, molybdenum, copper, aluminum, gold, and silver. The metal layer may be formed by a chemical vapor deposition (CVD) method or physical vapor deposition (PVD) method. The photoresist patterns 20 and the ink absorption layer 30, which are stacked on the substrate 10, may have a fine line width of about 5 μm or more and a high aspect ratio of about 10 μm or more.

Therefore, the manufacturing method of the cliche according to the first embodiment of the inventive concept can increase or maximize productivity and production yield.

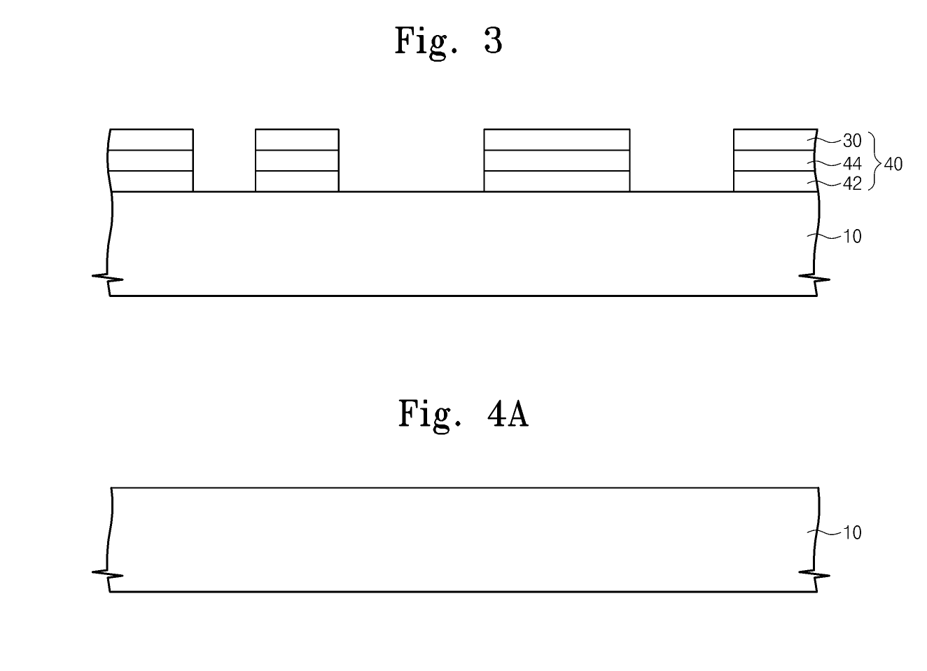

FIG. 3 is a cross-sectional view illustrating a cliche according to a second embodiment of the inventive concept.

Referring to FIG. 3, the cliche according to the second embodiment of the inventive concept may include first and second metal layers 42 and 44 stacked on a substrate 10 and metal patterns 40 composed of an ink absorption layer 30. The substrate 10 may include a plate of metal such as copper, bronze, brass, and stainless steel. The first and second metal layers 42 and 44, and the ink absorption layer 30 may be composed of the same or different kinds of metals. The first and second metal layers 42 and 44 may include raised stack patterns protruding on the substrate 10. The ink absorption layer 30 may include a layer of metal such as chromium, nickel, aluminum, or molybdenum. The metal patterns 40 may further include at least one of another metal layer in addition to the first and second metal layers 42 and 44 and the ink absorption layer 30. The metal patterns 40 may have a fine line width of about 5 μm or more, and a high aspect ratio of about 10 μm or more from the substrate 10. Therefore, the cliche according to the second embodiment of the inventive concept can increase or maximize productivity and production yield.

A manufacturing method of a cliche according to the second embodiment of the inventive concept having the foregoing configuration is described as follows.

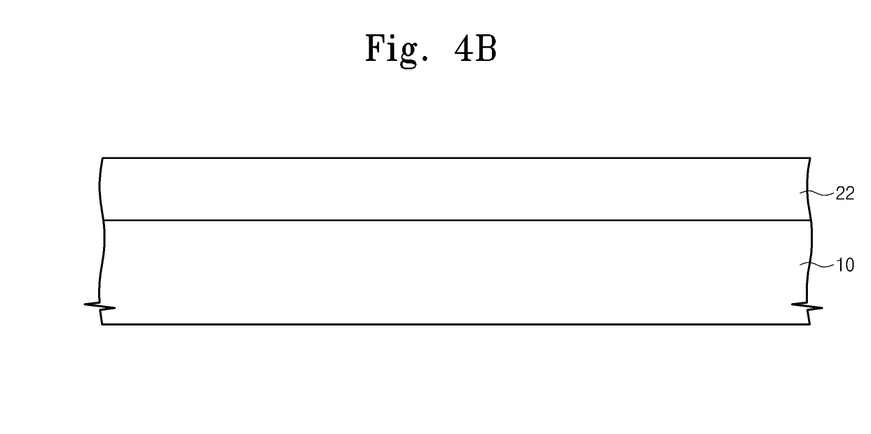

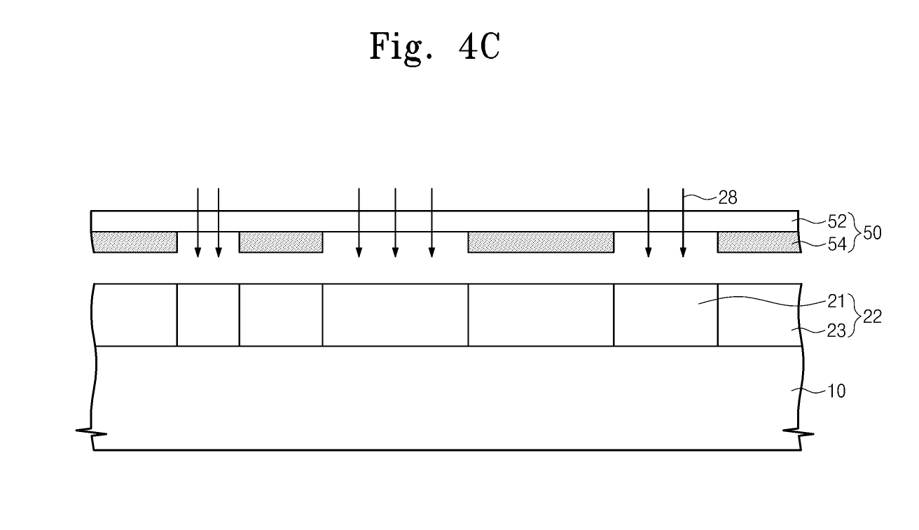

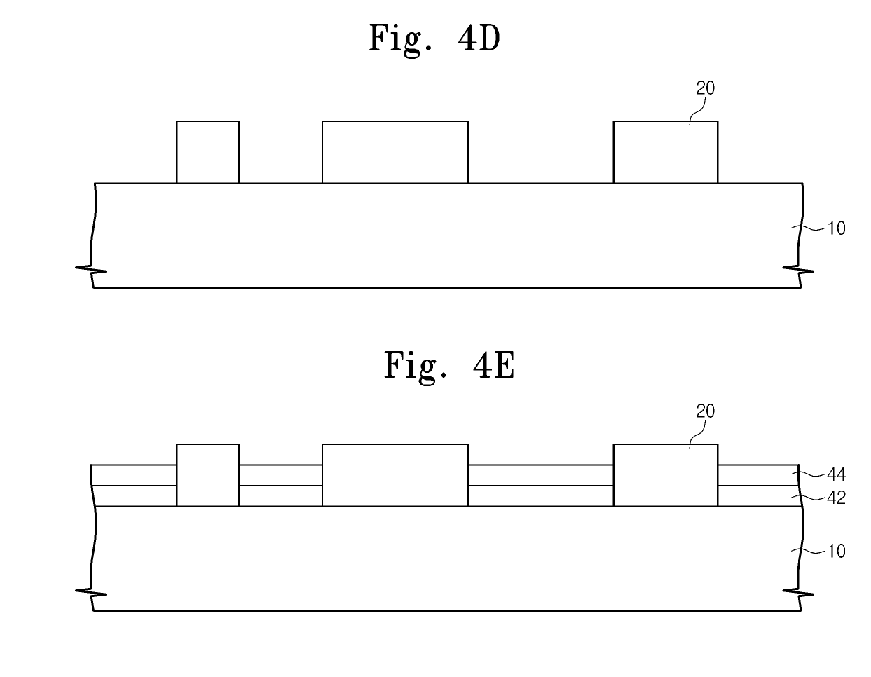

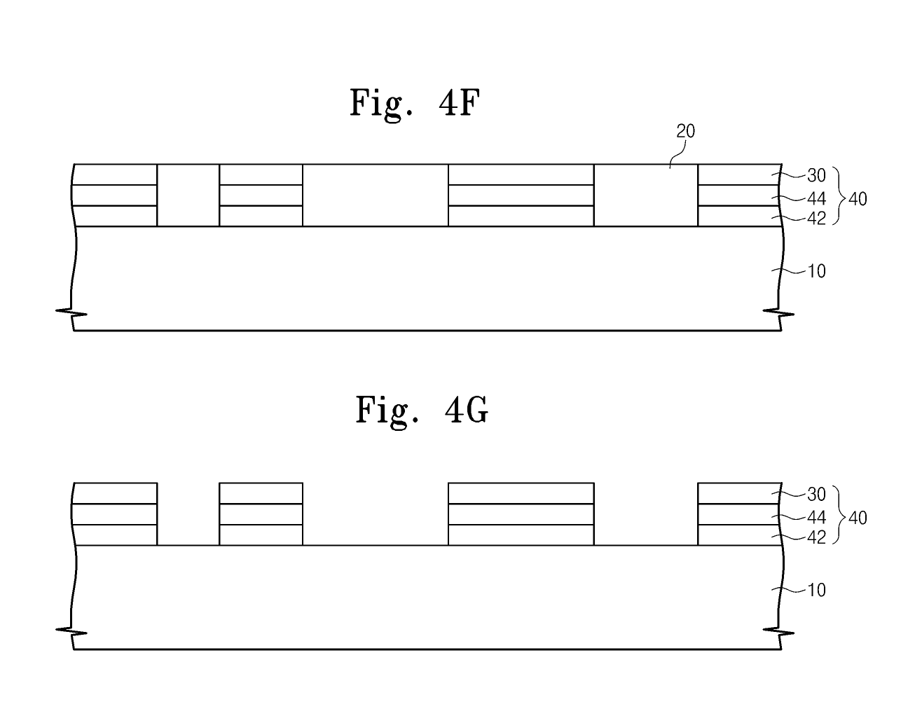

FIGS. 4A through 4G are cross-sectional views illustrating the manufacturing method for the cliche according to the second embodiment of the inventive concept.

Referring to FIG. 4A, a substrate 10 may be provided. The substrate 10 may include a metal plate.

Referring to FIG. 4B, a photoresist 22 may be formed on the substrate 10. The photoresist 22 may be applied by a spin coater (not shown). The photoresist 22 may include a negative-type SU-8 photoresist. The photoresist 22 may be formed to a thickness of about 10 μm or more.

Referring to FIG. 4C, the photoresist 22 may be exposed to ultraviolet rays 28. The photoresist 22 may be exposed to the ultraviolet rays 28 passing through a photomask 50. The photomask 50 may include a transparent glass substrate 52 and mask patterns 54 formed on the glass substrate 52. The mask patterns 54 may selectively shield the ultraviolet rays 28 which are incident on the photoresist 22 from a light source (not shown). The photoresist 22 may include an exposed region 21 exposed to the ultraviolet rays and an unexposed region 23 unexposed to the ultraviolet rays in which their chemical structures may be different from each other. For example, a negative-type photoresist 22 may include polymer. The photoresist 22 may form a polymer chain when being exposed to the ultraviolet rays 28.

Referring to FIG. 4D, the photoresist 22 of the unexposed region 23 may be developed. The photoresist 22 of the unexposed region 23 may be removed by a developer. The photoresist 22 of the exposed region 21 may become photoresist patterns 20 remaining on the substrate 10. Therefore, the photoresist patterns 20 may be formed by a photolithography process. Thereafter, the photoresist patterns 20 may be subjected to a bake process.

Referring to FIG. 4E, first and second metal layers 42 and 44 may be formed on the substrate 10 exposed from the photoresist patterns 20. The first and second metal layers 42 and 44 may include the same or different kinds of metals. The first and second metal layers 42 and 44 may be formed by an electroplating method, an electro-precipitation method, or an anodizing method. The first metal layer 42 may be precipitated on the substrate 10 dipped in an electrolyte solution containing a metal ion. The substrate 10 may be connected to an external power source voltage. For example, the substrate 10 may be connected to a positive electrode which is connected to a direct current power source. At this time, a negative electrode may be dipped in the electrolyte solution.

Referring to FIG. 4F, an ink absorption layer 30 may be formed on the first and second metal layers 42 and 44. The ink absorption layer 30 may include the same or different kinds of metals from the first and second metal layers 42 and 44. The ink absorption layer 30, like the first and second metal layers 42 and 44, may be formed by an electroplating method, an electro-precipitation method, or an anodizing method. The first and second metal layers 42 and 44 and the ink absorption layer 30 may be formed up to a level corresponding to a top of the photoresist patterns 20. Therefore, metal patterns 40 may have a height of about 10 μm or more.

Referring to FIG. 4G, the photoresist patterns 20 between the metal patterns 40 may be removed. The photoresist patterns 20 may be removed by a volatile cleaning liquid containing acetone or methyl alcohol, or an ashing treatment

Therefore, the manufacturing method of the cliche according to the second embodiment of the inventive concept can increase or maximize productivity and production yield.

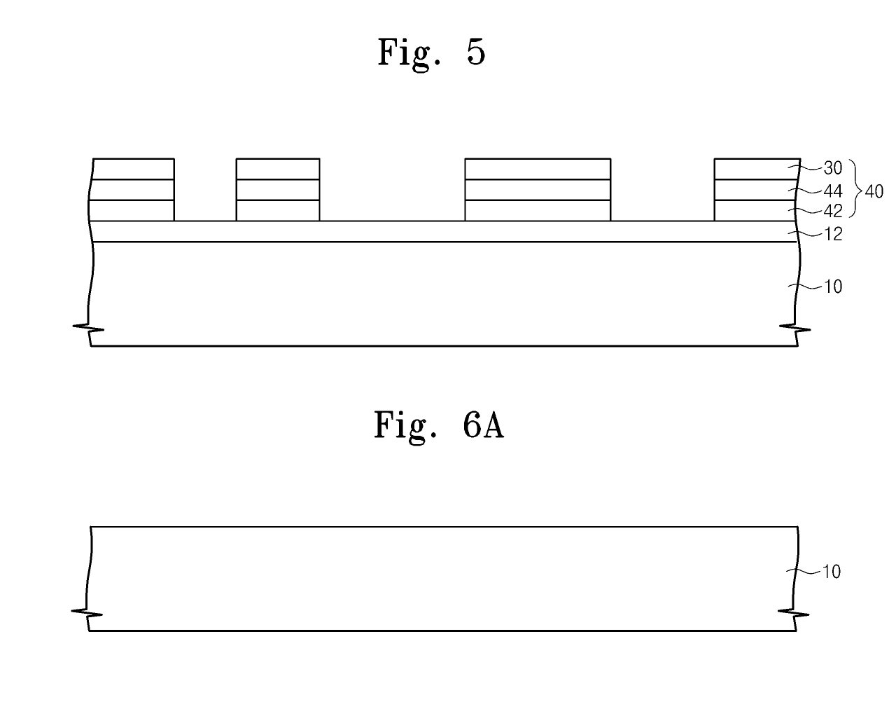

FIG. 5 is a cross-sectional view illustrating a cliche according to a third embodiment of the inventive concept.

Referring to FIG. 5, the cliche according to the third embodiment of the inventive concept may include an electrode layer 12 formed on an entire surface of a substrate 10 under metal patterns 40. The electrode layer 12 may include a thin film of metal such as copper, aluminum, tungsten, or chromium. The substrate 10 may include a plate of an insulation material such as glass, ceramic, or plastic, or a metal plate. The metal patterns 40 may include first and second metal layers 42 and 44, and an ink absorption layer 30 which are composed of the same or different metals from each other. The first and second metal layers 42 and 44 may include raised stack patterns protruding on the substrate 10. The ink absorption layer 30 may include chromium, nickel, aluminum, or molybdenum. The metal patterns 40 may have a fine line width of about 5 μm or more. The metal patterns 40 may have a high aspect ratio of about 10 μm or more from the electrode layer 12. Therefore, the cliche according to the third embodiment of the inventive concept can increase or maximize productivity and production yield.

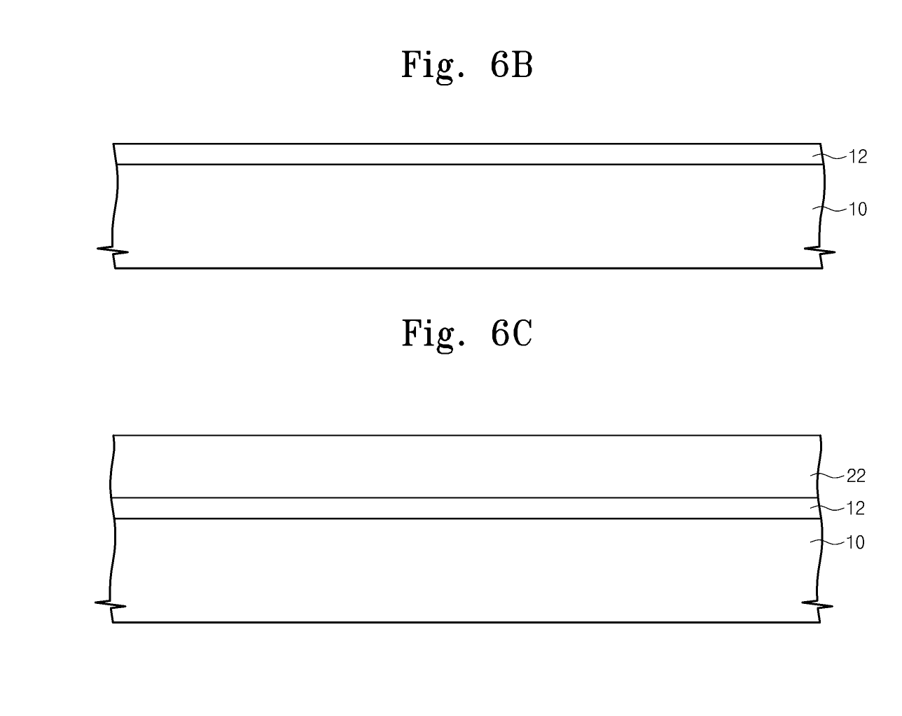

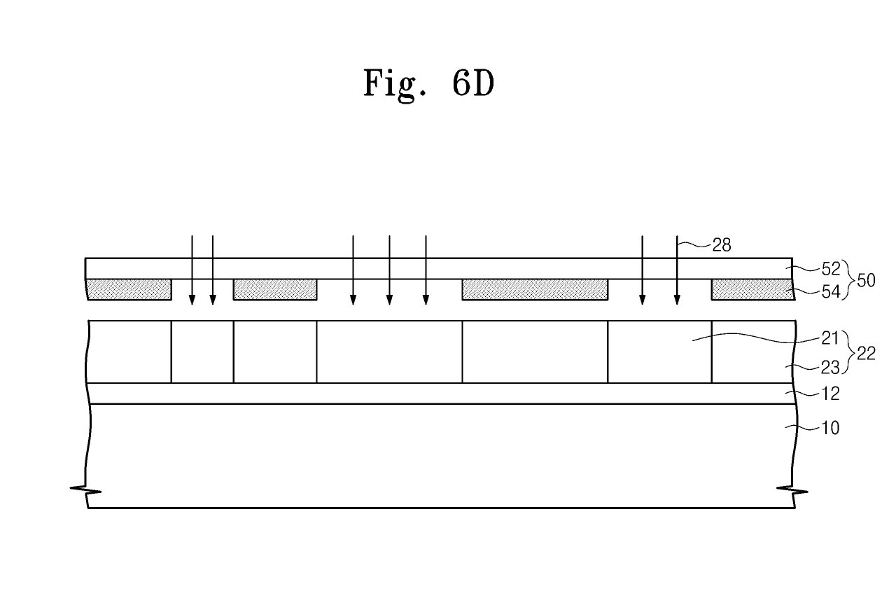

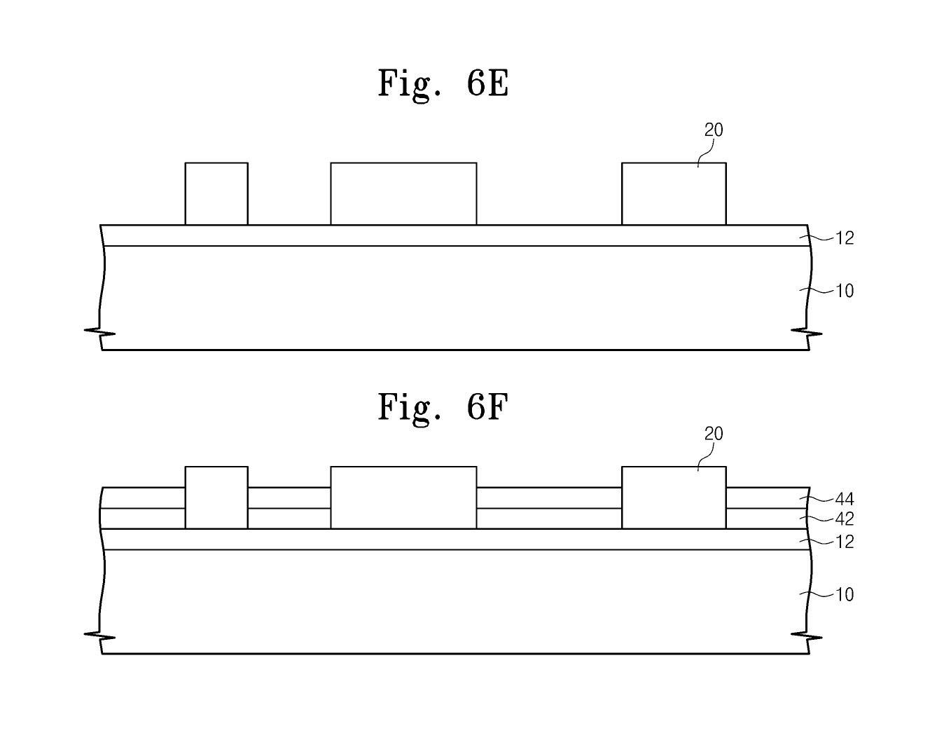

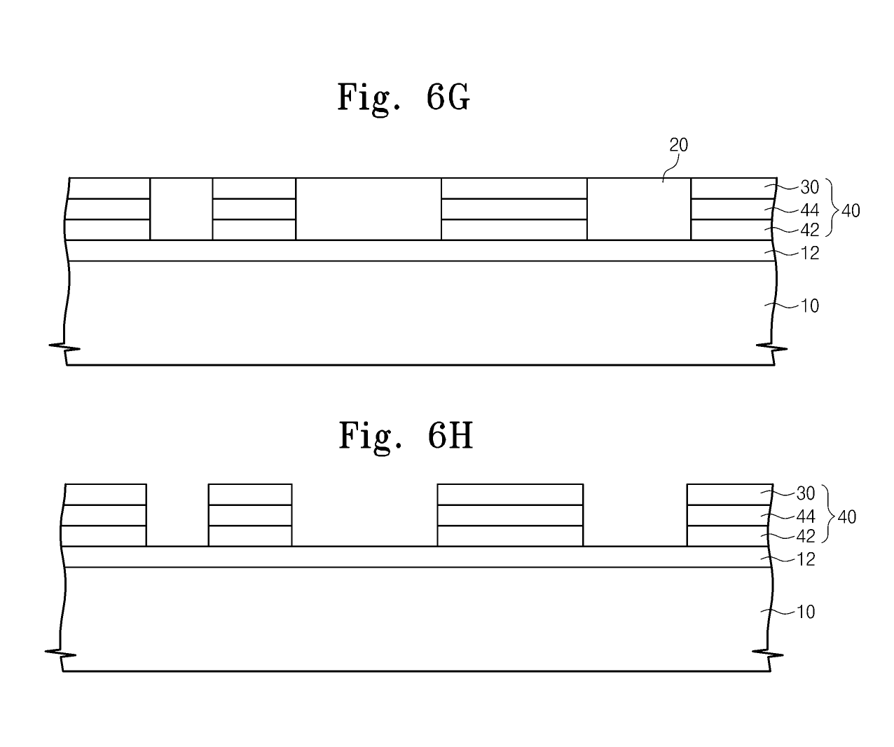

FIGS. 6A through 6H are cross-sectional views illustrating a manufacturing method for a cliche according to the third embodiment of the inventive concept.

Referring to FIG. 6A, a substrate 10 may be provided. The substrate 10 may include a flat plate of an insulation material such as glass, ceramic, or plastic, or a wafer.

Referring to FIG. 6B, an electrode layer 12 may be formed on the substrate 10. The electrode layer 12 may be formed by at least one of a chemical vapor deposition method, a physical vapor deposition method, or a liquid phase epitaxy (LPE) method.

Referring to FIG. 6C, a photoresist 22 may be applied on the electrode layer 12. The photoresist 22 may be applied by a spin coater (not shown). The photoresist 22 may include a negative-type SU-8 photoresist. The photoresist 22 may be applied to a thickness of about 10 μm or more.

Referring to FIG. 6D, the photoresist 22 may be exposed to ultraviolet rays 28. The photoresist 22 may be exposed to the ultraviolet rays 28 passing through a photomask 50. The photomask 50 may include a transparent glass substrate 52 and mask patterns 54 formed on the glass substrate 52. The mask patterns 54 may selectively shield the ultraviolet rays 28 which are incident on the photoresist 22 from a light source (not shown). The photoresist 22 may include an exposed region 21 exposed to the ultraviolet rays and an unexposed region 23 unexposed to the ultraviolet rays in which chemical bonding structures of constituents may be different from each other. For example, a negative-type photoresist 22 may include polymer. The negative-type photoresist 22 may form a polymer chain when exposed to the ultraviolet rays 28.

Referring to FIG. 6E, the photoresist 22 of the unexposed region 23 may be developed. The photoresist 22 of the unexposed region 23 may be removed by a developer. The photoresist 22 of the exposed region 21 may become photoresist patterns 20 remaining on the substrate 10. Thereafter, the photoresist patterns 20 may undergo a bake process.

Referring to FIGS. 6F and 6G, first and second metal layers 42 and 44 and an ink absorption layer 30 may be sequentially formed on the electrode layer 12 exposed from the photoresist patterns 20. The first and second metal layers 42 and 44 and the ink absorption layer 30 may be formed by an electroplating method, an electro-precipitation method, or an anodizing method. The first and second metal layers 42 and 44 and the ink absorption layer 30 may be precipitated on the electrode layer 12 of the substrate 10 dipped in an electrolyte solution containing a metal ion. The electrode layer 12 may be connected to an external power source voltage. For example, the electrode layer 12 may be connected to a positive electrode which is connected to a direct current power source. At this time, a negative electrode may be dipped in the electrolyte solution. The first and second metal layers 42 and 44 may include the same or different kinds of metals. Also, the ink absorption layer 30 may include the same or different kinds of metals from the first and second metal layers 42 and 44. The first and second metal layers 42 and 44 and the ink absorption layer 30 may be sequentially formed up to a level corresponding to a top of the photoresist patterns 20. Therefore, metal patterns 40 may have a height of about 10 μm or more.

Referring to FIG. 6H, the photoresist patterns 20 between the metal patterns 40 may be removed. The photoresist patterns 20 may be dissolved by a component of acetone or methyl alcohol, or removed by an ashing treatment

Therefore, the manufacturing method of the cliche according to the third embodiment of the inventive concept can increase or maximize productivity and production yield.

As described above, according to the exemplary embodiments of the inventive concept, an ink absorption layer may be formed on a top of photoresist patterns patterned on a substrate or on the substrate exposed from the photoresist patterns. The photoresist patterns and the ink absorption layer may have a fine line width and a high aspect ratio. Therefore, a cliche and a manufacturing method of the cliche according to embodiments of the inventive concept can increase or maximize productivity and production yield.

While this inventive concept has been particularly shown and described with reference to preferred embodiments thereof, it will be understood by those skilled in the art that various changes in form and details may be made therein without departing from the spirit and scope of the inventive concept as defined by the appended claims. The preferred embodiments should be considered in descriptive sense only and not for purposes of limitation.

What is claimed is:

1. A method of manufacturing a cliche, the method comprising:
providing a substrate;
forming organic patterns on the substrate; and
forming an ink absorption layer on the organic patterns or on the substrate exposed from the organic patterns.

2. The method of claim 1, wherein the organic patterns comprise a photoresist.

3. The method of claim 2, wherein the photoresist is of a negative-type.

4. The method of claim 3, wherein the negative-type photoresist comprises a SU-8 photoresist.

5. The method of claim 1, wherein the ink absorption layer comprises at least one metal layer.

6. The method of claim 5, wherein the metal layer between the organic patterns is formed by an electroplating method, an electro-precipitation method, or an anodizing method.

7. The method of claim 6, further comprising removing the organic patterns between the ink absorption layers.

8. A cliche comprising:
a substrate;
stack patterns protruding on the substrate; and
an ink absorption layer formed on the stack patterns.

9. The cliche of claim 8, wherein the stack patterns comprise organic patterns.

10. The cliche of claim 9, wherein the organic patterns comprise a negative-type photoresist.

11. The cliche of claim 10, wherein the negative-type photoresist comprises an SU-8 photoresist.

12. The cliche of claim 8, wherein the ink absorption layer comprises a metal layer.

13. The cliche of claim 12, wherein the metal layer comprises at least one of chromium, nickel, aluminum, and molybdenum.

14. The cliche of claim 13, wherein the stack patterns comprise the same or different kinds of metal layers from the metal layer of the ink absorption layer.

15. The cliche of claim 14, wherein the substrate comprises a metal plate.

16. The cliche of claim 8, further comprising a metal thin film formed between the substrate and the stack patterns.
